(19) United States
(12) Patent Application Publication
(10) Pub. No.: US 2026/0084578 A1
(43) Pub. Date: Mar. 26, 2026

(54) METHOD AND GATEWAY DEVICE FOR RELAYING MESSAGE FOR TERMINAL EQUIPMENT

(71) Applicant: Moxa Inc., New Taipei City (TW)

(72) Inventors: Cheng-Ping Tung, New Taipei City (TW); Wei-Chi Ma, New Taipei City (TW); Ting-Song Hu, New Taipei City (TW)

(73) Assignee: Moxa Inc., New Taipei City (TW)

(21) Appl. No.: 18/974,820

(22) Filed: Dec. 10, 2024

Related U.S. Application Data
(60) Provisional application No. 63/699,162, filed on Sep. 26, 2024.

(51) Int. Cl. B60L 53/68; H04W 80/12; H04W 88/16

(52) U.S. Cl. CPC B60L 53/68; H04W 80/12; H04W 88/16

(57) ABSTRACT

A method and a gateway device for relaying message for terminal equipment are provided. A first protocol message complied with a first application layer protocol is received from a terminal equipment. The first protocol message complying with the first application layer protocol is transmitted to a first remote server. The first protocol message is converted to a second protocol message complying with a second application layer protocol. The second protocol message complying with the second application layer protocol is transmitted to the second remote server.

### CROSS-REFERENCE TO RELATED APPLICATION

This application claims the priority benefit of U.S. provisional application Ser. No. 63/699,162, filed on Sep. 26, 2024. The entirety of the above-mentioned patent application is hereby incorporated by reference herein and made a part of this specification.

### BACKGROUND

### Technical Field

The disclosure is directed to a method and a gateway device for relaying message for terminal equipment.

### Description of Related Art

As technology continues to advance and environmental awareness grows, the development of electric vehicles (EVs) powered by electricity as an alternative to fossil fuel-powered vehicles has become a key objective in the automotive sector. In recent years, the adoption of electric vehicles, such as electric buses, cars, and motorcycles, has been increasing rapidly. Consequently, the rise in the number of electric vehicles has led to the widespread installation of charging stations in various regions. The charging stations are usually connected to a charging point management system, enabling remote monitoring and management. Specifically, the charging stations may be connected to a server of charge point operators via the internet or power grid.

Currently, the Open Charge Point Protocol (OCPP) has become a common application layer communication protocol between charging stations and the servers of charging point management system. In an OCPP-based environment, charging stations communicate directly with operators' OCPP servers to manage charging activities. However, when a charging station malfunctions or operates abnormally, the operator owning the charging point management system may not have the capacity to address the issue, necessitating the intervention of the charging station's equipment manufacturer for troubleshooting.

Unfortunately, equipment manufacturers often lack real-time data from the charging station, leaving them unable to proactively monitor the equipment or address potential issues before they escalate. This leads to a reactive approach, where the manufacturer can only begin diagnosing and resolving the issue after it has been reported by the operator. This reactive process can potentially cause delays in maintenance and increased downtime for the charging stations. Therefore, ensuring that manufacturers have access to timely information is crucial for efficient management and the quick resolution of any issues that may arise within the charging infrastructure.

### SUMMARY

The disclosure is directed to a method and a gateway device for relaying message for terminal equipment, which are adapted to solve the above mentioned technical problems.

An embodiment of the disclosure provides a method for relaying message for terminal equipment, which is adapted to a gateway device and includes following steps. A first protocol message complied with a first application layer protocol is received from a terminal equipment. The first protocol message complying with the first application layer protocol is transmitted to a first remote server. The first protocol message is converted to a second protocol message complying with a second application layer protocol. The second protocol message complying with the second application layer protocol is transmitted to the second remote server.

An embodiment of the disclosure provides a gateway device including a transmitter, a storage device and a processor. The processor is coupled to the storage device and the transmitter and configured to: receive a first protocol message complied with a first application layer protocol from a terminal equipment; transmit the first protocol message complying with the first application layer protocol to the first remote server; convert the first protocol message to a second protocol message complying with a second application layer protocol; and transmit the second protocol message complying with the second application layer protocol to the second remote server.

Based on the above description, in the embodiments of the disclosure, the terminal equipment is able to synchronously transmit the same data to the different server using different application layer protocols.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram that illustrates a terminal equipment management system according to an exemplary embodiment of the disclosure.

FIG. 2 is a hardware block diagram that illustrates a gateway according to an exemplary embodiment of the disclosure.

FIG. 3 is a flowchart of a method of a method for relaying message for terminal equipment according to an exemplary embodiment of the disclosure.

FIG. 4 is a schematic diagram that illustrates a method for relaying message for terminal equipment according to an exemplary embodiment of the present disclosure.

FIG. 5 is a schematic diagram that illustrates a method for relaying message for terminal equipment according to an exemplary embodiment of the present disclosure.

FIG. 6 is a schematic diagram that illustrates a method for relaying message for terminal equipment according to an exemplary embodiment of the present disclosure.

FIG. 7 is a schematic diagram that illustrates operation of the connection handlers according to an exemplary embodiment of the present disclosure.

FIG. 8 is a schematic diagram that illustrates relation between local OCPP server and multiple connection handlers according to an exemplary embodiment of the present disclosure.

FIG. 9 is a schematic diagram that illustrates a method for relaying message for terminal equipment according to an exemplary embodiment of the present disclosure.

FIG. 10 is a schematic diagram that illustrates relation between local OCPP server and multiple connection handlers according to an exemplary embodiment of the present disclosure.

FIG. 11 is a schematic diagram that illustrates operation of a connection handler according to an exemplary embodiment of the present disclosure.

### DESCRIPTION OF THE EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

This disclosure is directed to a method for relaying message for terminal equipment. In the disclosure, a Y-shaped data architecture is adopted to handle the messages sent from or sent to terminal equipments. The messages sent by a terminal equipment may be synchronously relayed to a first remote server applying a first application layer protocol and a second remote server applying a second application layer protocol. Therefore, in an embodiments, the messages sent by a terminal equipment may be not only transmitted to a OCPP server but also to another server that do not support OCPP. Further, messages sent by the first remote server applying the first application layer protocol and messages sent by the second remote server applying the second application layer protocol may both be relayed to a terminal equipment. In an embodiment, a terminal equipment may receive messages from the servers that applying the different application layer protocols. Therefore, messages from the server that do not support OCPP may be relayed to the terminal equipment.

From another perspective, the disclosure provides a gateway device for relaying message for terminal equipment. In the disclosure, the gateway device may function as the branching node in the Y-shaped data architecture. The gateway device may relay a message sent by a terminal equipment to a first remote server applying a first application layer protocol and a second remote server applying a second application layer protocol. Further, the gateway device may relay messages sent by the first remote server applying the first application layer protocol and messages sent by the second remote server applying the second application layer protocol to a terminal equipment. In some embodiments, the gateway device may perform application layer protocol conversion processing on the message, so as to transmit the message from the terminal equipment to a server that supports other application layer protocol or to transmit the message from the server that supports other application layer protocol to the terminal equipment.

In some embodiments, the terminal equipment may be a charging station applying OCPP or other equipment managed by different operators. The terminal equipment may be managed or controlled by servers of the different operators through different application protocols. For ease of understanding, the following embodiments are primarily explained using charging stations as examples; however, the present disclosure is not limited thereto.

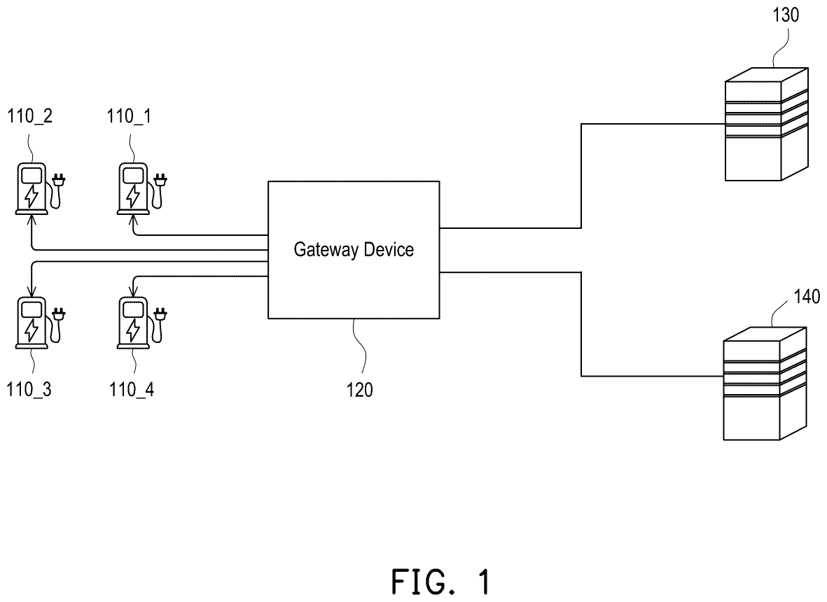

FIG. 1 is a schematic diagram that illustrates a terminal equipment management system according to an exemplary embodiment of the disclosure. Referring to FIG. 1, a terminal equipment management system includes a plurality of charging stations 110_1 to 110_4, a gateway device 120, a first remote server 130, and a second remote server 140. The gateway device 120 is connected between the charging stations 110_1 to 110_4 and the first remote server 130. The gateway device 120 is connected between the charging stations 110_1 to 110_4 and the second remote server 140. The embodiments disclosed herein use four charging stations 110_1 to 110_4 as an example; however, this disclosure does not limit the number of charging stations that can be connected to the gateway device 120.

The charging stations 110_1 to 110_4, also known as charge points, are power supply devices that supply electrical power for recharging plug-in electric vehicles, such as battery electric vehicles, electric trucks, electric buses, plug-in hybrid vehicles, and so forth. In various embodiments, the charging stations 110_1 to 110_4 may be connected to the gateway device 120 through wired communication interface or wireless communication interface. In some embodiments, the charging stations 110_1 to 110_4 may communicate with other device according to Open Charge Point Protocol (OCPP). The messages generated by the charging stations 110_1 to 110_4 may comply with the OCPP format.

In some embodiments, the gateway device 120 may be a IoT gateway or another type of network device. In various embodiments, the gateway device 120 may be connected to the first remote server 130 and the second remote server 140 through wired communication interface or wireless communication interface. In some embodiments, the gateway device 120 may be connected to the first remote server 130 and the second remote server 140 through Internet. In some embodiments, the gateway device 120 may be connected to the first remote server 130 and the second remote server 140 through public network or local network.

In some embodiments, the first remote server 130 may support a first application layer protocol. That is, the first remote server 130 can parse a message that is generate based on the first application layer protocol and can generate a message based on the first application layer protocol. In some embodiments, the first remote server 130 may be a remote OCPP server that supports OCPP. For example, the first remote server 130 may be owned and operated by a charging station operator (CPO). Namely, in some embodiments, both the first remote server 130 and each of the charging stations 110_1 to 110_4 may communicate with each other based on OCPP. In some embodiments, each charging station 110_1 to 110_4 may act as a client that initiates a WebSocket connection to the first remote server 130 of the Charging Point Operator (CPO) using TCP and mTLS (mutual TLS).

In some embodiments, the second remote server 140 may support a second application layer protocol. The second application layer protocol is different from the first application layer protocol supported by the first remote server 130. In some embodiments, the second remote server 130 may be a remote Modbus server or a OPCUA server that support Modbus protocol or OPCUA protocol. For example, the second remote server 140 may be owned and operated by a hardware vendor of the charging stations 110_1 to 110_4. Alternatively, the second remote server 140 may be part of an energy management system (EMS) or a battery management system (BMS), wherein the EMS and BMS function as external entities to the charging infrastructure.

In some embodiments, both of the first remote server 130 and the charging station may support OCPP, but the second remote server 140 does not support OCPP.

In some embodiments, the second remote server 140 may be connected to the gateway device 120 via a local controller, and the second protocol message may be transmitted to the second remote server 140 via the local controller. In some embodiments, the local controller connected to the charging stations 110_1 to 110_4 may be a programmable logic controller (PLC). That is, the PLC may be connected between the gateway device 120 and the second remote server 140. For example, a external server of a EMS system may connect to the gateway device 120 via a PLC.

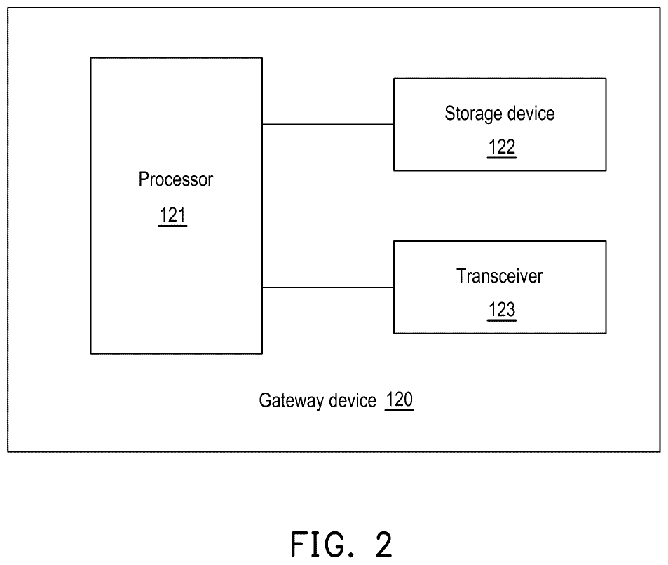

FIG. 2 is a hardware block diagram that illustrates a gateway device according to an exemplary embodiment of the disclosure. Referring to FIG. 2, the gateway device 120 may include, but is not limited thereto a processor 121, a storage device 122 and transceiver 123. The processor 121 (e.g., having processing circuitry) may include an intelligent hardware device, e.g., a Central Processing Unit (CPU), a microcontroller, a digital signal processor (DSP), a graphics processing unit (GPU), a field programmable gate array (FPGA), an ASIC, or a device having a similar function. The processor 121 can access and run a computer program from a memory to implement the method in the embodiment of the disclosure.

Since the program code stored in the gateway device 120 adopts all the technical solutions of all the embodiments when being executed by the processor 121, it at least has all the advantageous effects brought by all the technical solutions of all the embodiments, and no further description is incorporated herein.

As shown in FIG. 2, the gateway device 120 may further include a storage device 122. The storage device 122 may include computer-storage media in the form of volatile and/or non-volatile memory. The storage device 122 may be removable, non-removable, or a combination thereof. Exemplary memory includes solid-state memory, hard drives, read only memory (ROM), flash memory, and etc. The processor 121 may call and run a computer program from the storage device 122 to implement the method in the embodiment of the disclosure.

The memory 122 may be a separate device independent of the processor 121, or may be integrated in the processor 121.

As shown in FIG. 2, the gateway device 120 may further include a transceiver 123, and the processor 121 may control the transceiver 123 to communicate with other devices. The transceiver 123 having a transmitter (e.g., transmitting/transmission circuitry) and a receiver (e.g., receiving/reception circuitry) may be configured to transmit and/or receive time and/or frequency resource partitioning information. The transceiver 123 may execute operations of Low Noise Amplifying (LNA), impedance matching, analog-to-digital (ADC) converting, digital-to-analog (DAC) converting, frequency mixing, up-down frequency conversion, filtering, amplifying and/or similar operations. For example, the transceiver 123 may be Wi-Fi or Bluetooth transceiver meeting the 802.xx standard. For example, transceiver 123 may be included in a USB port or an interface for facilitating a cabled connection.

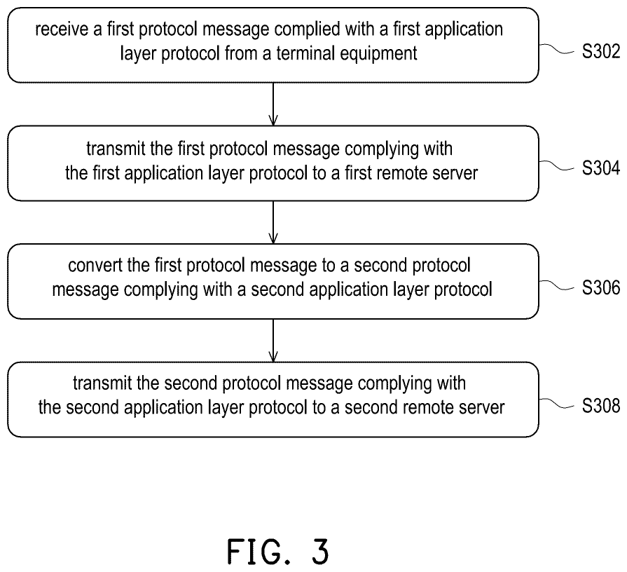

FIG. 3 is a flowchart of a method of a method for relaying message for terminal equipment according to an exemplary embodiment of the disclosure. Referring to FIG. 1 and FIG. 3, the method of the embodiment is adapted to the terminal equipment management system in the above-mentioned embodiment. Detailed steps of the method for recommending report material of the embodiment will be described below with reference of various components in the terminal equipment management system.

In step S302, the gateway device 120 may receive a first protocol message complied with a first application layer protocol from a terminal equipment (e.g., any one of charging stations 110_1 to 110_4).

In some embodiments, the first protocol message may be generated by the charging station according to the first application layer protocol. The gateway device 120 may receive the first protocol message from the charging station. The first protocol message may include terminal equipment information (e.g., charging station information), EV information, or customer information. The charging station information may include operation state, charging current and charging voltage of a charging station.

In some embodiments, the first protocol message may be a OCPP message generated by a charging station. That is, in some embodiments, the first application layer protocol may be OCPP.

In step S304, the gateway device 120 may transmit the first protocol message complying with the first application layer protocol to the first remote server 140. Since the first remote server 130 may support the first application layer protocol, the first remote server 130 is able to parsing the first protocol message correctly.

In step S306, the gateway device 120 may convert the first protocol message to a second protocol message complying with a second application layer protocol. In some embodiments, the second application layer protocol is different form the first application layer protocol. The second application layer protocol may be Modbus protocol, OPCUA protocol or other application layer protocol.

In some embodiments, the gateway device 120 may parse the first protocol message to obtain the payload information in the first protocol message. Next, the gateway device 120 may generate a protocol data with an indication tag according to the payload information, and encapsulate the protocol data with the indication tag into the second protocol message according to the second application layer protocol.

In some embodiments, in response to a message type of the first protocol message satisfying a filtering condition, the gateway device 120 may generate the indication tag by combining the message type of the first protocol message and a client ID of the terminal equipment (i.e. client ID of the charging station). The gateway device 120 may add the indication tag to the payload information of the first protocol message to generating the protocol data with the indication tag. Otherwise, in response to the message type of the first protocol message not satisfying the filtering condition, the gateway device 120 may not generate the indication tag and the first protocol message may not be converted onto the second protocol message. If the message type of the first protocol message is one of specific message types, the message type of the first protocol message satisfies the filtering condition. If the message type of the first protocol message is not any one of specific message types, the message type of the first protocol message does not satisfy the filtering condition. For example, the specific message types may be BootNotification, MeterValues, Heartbeat, but the disclosure is not limited thereto.

In some embodiments, in response to the indication tag the protocol data is a specific indication tag, the gateway device 120 may perform a protocol converting process to encapsulate the protocol data into the second protocol message according to the second application layer protocol. Otherwise, in response to the indication tag of the protocol data is not the specific indication tag, the gateway device 120 may be disable to performing the protocol converting process. In some embodiments, the indication tag may be created according to the charging station ID, the message type and/or other information related to the first protocol message. Therefore, in some embodiments, the gateway device 120 is able to optionally relaying the messages to the second remote server 140. For example, a first protocol message with the indication tag including a first message type may be converted into a second protocol message. A first protocol message with the indication tag including a second message type may not be converted into a second protocol message.

In step S308, the gateway device 120 may transmit the second protocol message complying with the second application layer protocol to the second remote server 140. Since the second remote server 140 may support the second application layer protocol, the second remote server 140 is able to parsing the second protocol message correctly.

Since the first protocol message and the second protocol message carry the same payload information and are transmitted to the first remote server 130 and the second remote server 140 respectively, the data from the terminal equipment (e.g., any one of charging stations 110_1 to 110_4) may be transmitted using a Y-shaped data architecture. The gateway device 120 serving as a branch node of the Y-shaped data architecture may preform message relaying and protocol conversion. Such that, the data provided by the charging station may be received by servers operated by charging station operator and other entities, thereby achieving enhanced equipment management capabilities in the OCPP domain.

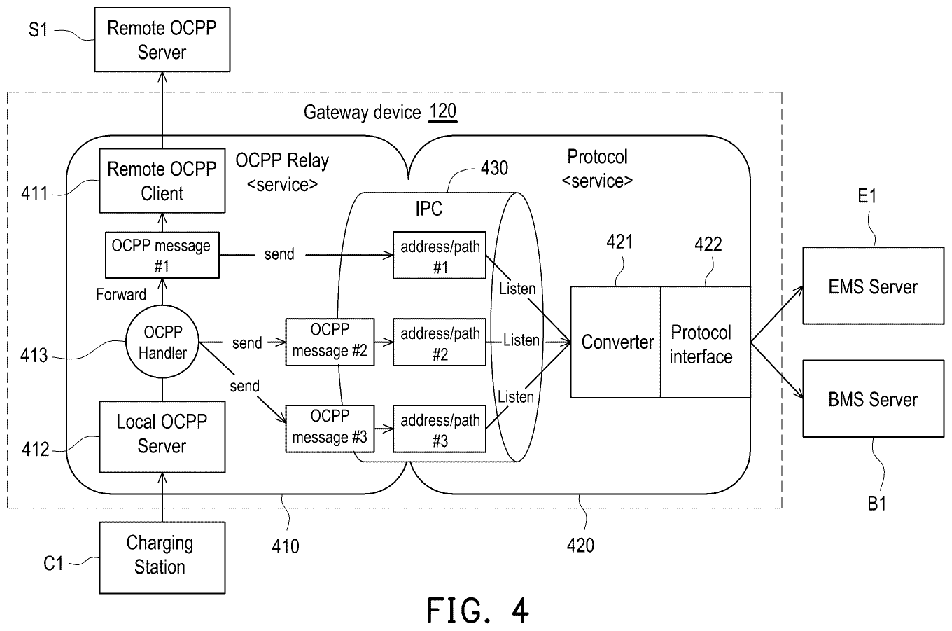

FIG. 4 is a schematic diagram that illustrates a method for relaying message for terminal equipment according to an exemplary embodiment of the present disclosure. Referring to FIG. 4, the gateway device 120 may perform a OCPP relay service 410 and a protocol service 420 to implement the method in FIG. 3. The OCPP relay service 410 may be a software module which responsible for forwarding OCPP messages between the remote OCPP Client 411 and the local OCPP server 412. The protocol service 420 may be a software module which responsible for protocol conversion. The OCPP relay service 410 and the protocol service 420 may communicate with each other through Inter-Process Communication (IPC) module 430.

A plurality of charging stations (e.g. charging station C1) may respectively establish links with the local OCPP server 412 configured by the gateway device 120. A charging station C1 may initiate communication by sending an OCPP message (i.e., a first protocol message) to the local OCPP server 412. The OCPP message may include various types of data, such as status updates, charging session information, or error reports. The local OCPP server 412 may receives the OCPP message from the charging station C1 and processes the OCPP message. The local OCPP server 412 may forward the OCPP message to a OCPP handler 413.

The gateway device 120 may build a dedicated OCPP handler for each charging station. For example, the gateway device 120 may build a OCPP handler 413 for each charging station C1. The OCPP handler 413 may forward the OCPP message to the remote OCPP client 411 and route the OCPP message through the Inter-Process Communication (IPC) module 430. The remote OCPP client 411 may receive the OCPP messages from the OCPP handler 413 and forward the OCPP messages to the remote OCPP server S1. Further, if the OCPP message needs to be sent to an external entity (i.e., an EMS server E1 or a BMS server B1) and converted into another protocol, the OCPP handler 413 may send the OCPP message with an indication tag to the IPC module 430.

The OCPP handler 413 may parse the OCPP message to obtain payload information in the OCPP message. The OCPP handler 413 may determine whether to create an indication tag for a OCPP message according to the message type of the OCPP message. The OCPP handler 413 may create the indication tag for each OCPP message according to the source device of the OCPP message or the message type of the OCPP message. For example, the indication tag may include an ID of the charging station C1 and a massage name. The indication tag may be a specific address/path for the OCPP message. For example, the indication tag ‘address/path #1’ is generated for the OCPP message #1. The indication tag ‘address/path #2’ is generated for the OCPP message #2. The indication tag ‘address/path #3’ is generated for the OCPP message #3. The indication tag is used to route the OCPP message by the IPC module 430 to the correct destination, such as the converter module 421, ensuring that the message is handled appropriately and reaches the intended external system (like EMS server E1 or BMS server B1).

The converter module 421 may receive the OCPP message through the IPC 430. The converter module 421 then encapsulate the protocol data with the indication tag into the second protocol message according to the second application layer protocol required by the target external entity, such as the EMS (Energy Management System) server E1 or BMS (Battery Management System) server B1. The protocol interface 422 acts as the final bridge between the converted message and the external systems. The protocol interface 422 may ensure that the message is formatted correctly and delivered to the EMS server E1 or BMS server B1 according to their specific communication protocols. Therefore, the data flow ensures that communication between the charging station C1 and external systems is seamless and efficient.

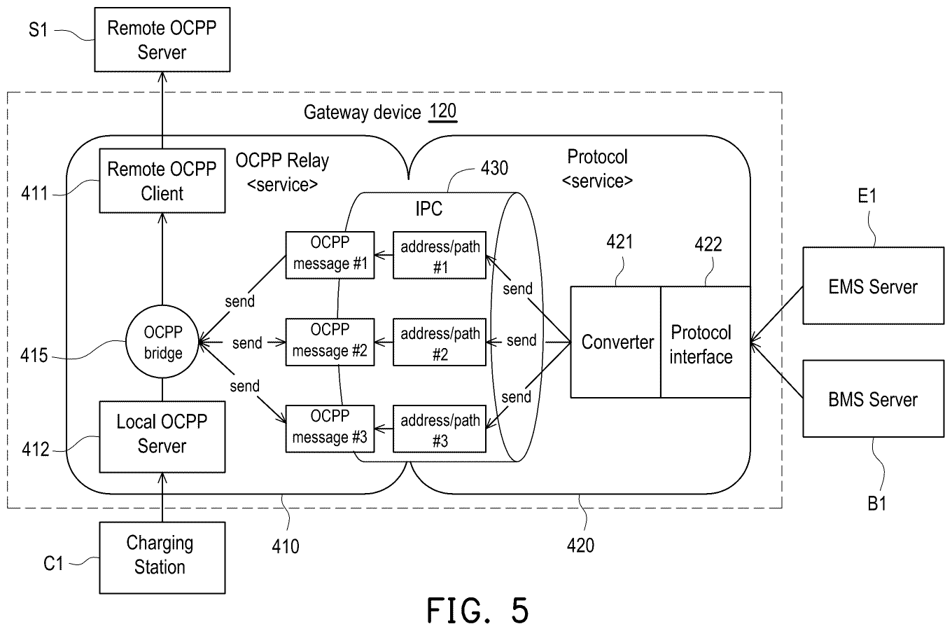

FIG. 5 is a schematic diagram that illustrates a method for relaying message for charging station according to an exemplary embodiment of the present disclosure. Referring to FIG. 5, the gateway device 120 may perform a OCPP relay service 410 and a protocol service 420. When the gateway device 120 receives the message from the EMS server E1 or the BMS server B1 that do not support OCCP, the converter module 421 may convert a specific protocol message complying a specific application layer protocol into a OCPP message. The IPC module 430 may forward the OCPP message to the OCPP bridge 415. The OCPP bridge 415 may forward the OCPP message to the local OCPP server 412, and the local OCPP server 412 may transmit the OCPP message to the charging station C1. Further, the OCPP message from the OCPP remote server S1 may be send to the charging station C1 via the remote OCPP Client 411, OCPP bridge 415, and a local OCPP server 412.

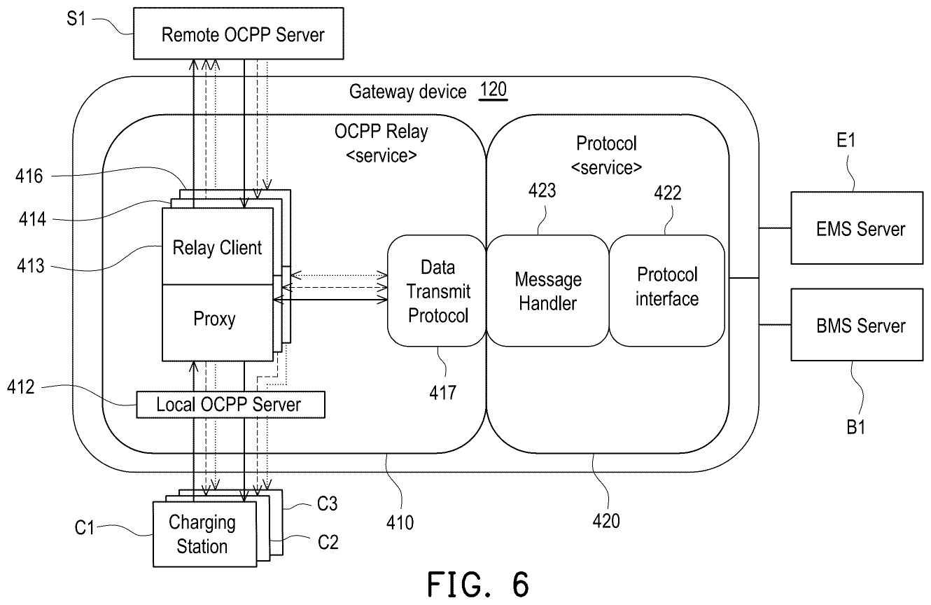

FIG. 6 is a schematic diagram that illustrates a method for relaying message for charging station according to an exemplary embodiment of the present disclosure. Referring to FIG. 6, the OCPP relay service 410 performed by the gateway device 120 may include multiple connection handlers 413, 414, 416 for multiple charging stations C1,C2 and C3, a local OCPP server 412, and a data transmit protocol module 417.

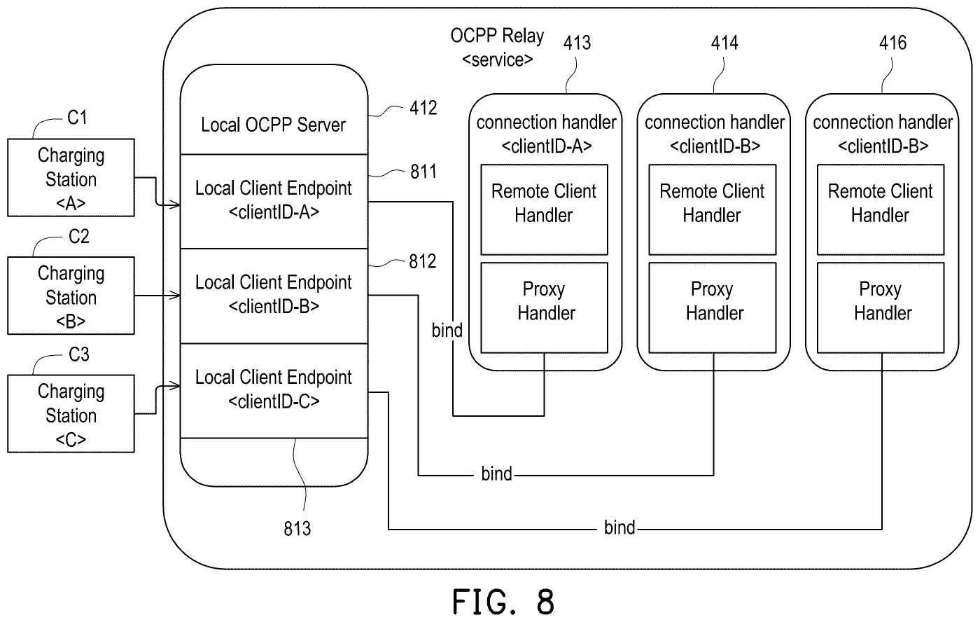

The local OCPP server 412 may identify the source charging station of the OCPP message and delivery the OCPP messages to a connection handler of the source charging station. For example, the local OCPP server 412 may identify the source charging station of the OCPP message is charging station C1, so as to delivery the OCPP message to a connection handler 413 of the charging station C1. Alternatively, the local OCPP server 412 may identify the source charging station of the OCPP message is charging station C2, so as to delivery the OCPP message to a connection handler 414 of the charging station C2. In detail, FIG. 8 is a schematic diagram that illustrates relation between local OCPP server 412 and multiple connection handlers 413, 414, 416 according to an exemplary embodiment of the present disclosure. By generate the local client endpoints 811˜813 for the multiple charging stations C1˜C3 and binding each local client endpoint 811˜813 to a proxy handler in a corresponding connection handler 413, 414, 416 each of the charging stations C1˜C3 may be connected to a dedicated connection handler 413, 414, 416. Each charging station C1˜C3 is identified by a unique ID {clientID}.

Referring to FIG. 6, a proxy handler in the connection handler 413, 414, 416 of each charging station C1˜C3 may create an indication tag for a OCPP message. For example, if a connection handler 413 is corresponding to a charging station C1 with a unique ID {ClientID-A}, a proxy handler of the connection handler 413 may receive the OCPP message from the charging station C1 with the unique ID {ClientID-A} and create an indication tag including the unique ID {ClientID-A} and a message type of the OCPP message for the OCPP message.

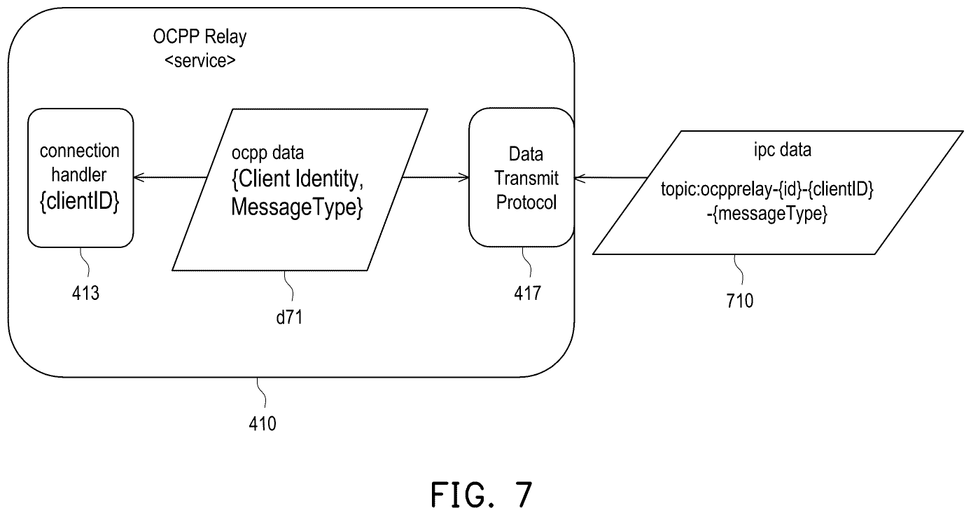

FIG. 7 is a schematic diagram that illustrates operation of the connection handlers according to an exemplary embodiment of the present disclosure. The connection handler 413 may transmit OCPP data d71 in the OCPP message with the indication tag including a client ID and a message type to the data transmit protocol module 417 to generate IPC data 710.

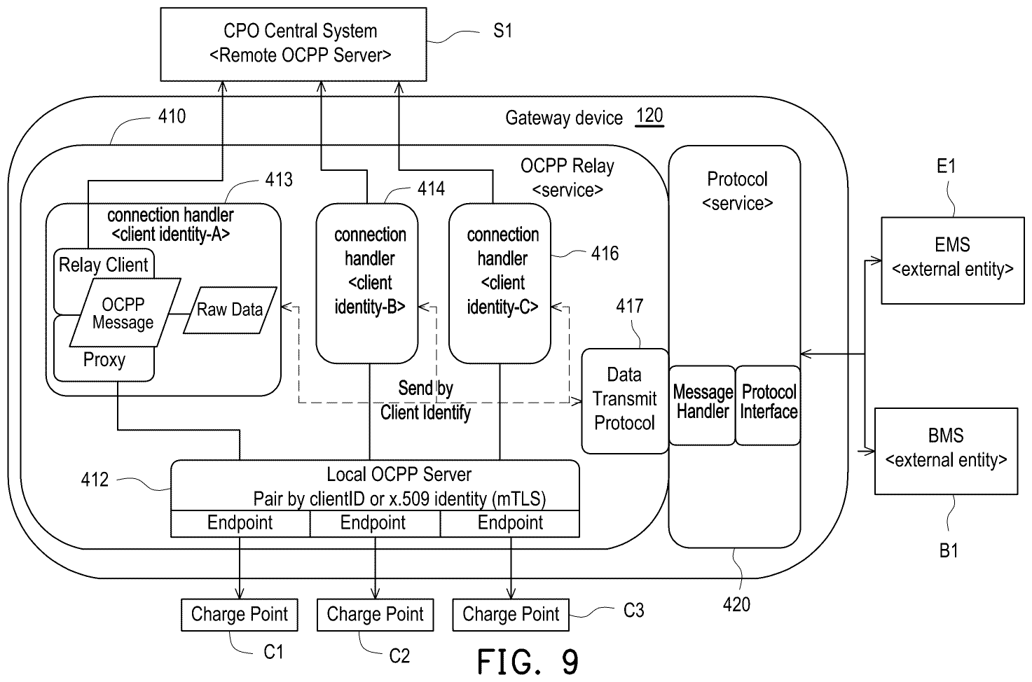

FIG. 9 is a schematic diagram that illustrates a method for relaying message for charging station according to an exemplary embodiment of the present disclosure. Referring to FIG. 9, the OCPP relay service 410 performed by the gateway device 120 may include three connection handlers 413, 414, 416 for three charging stations C1-C3, a local OCPP server 412, and a data transmit protocol module. The three charging stations C1-C3 respectively have the client IDs {A}, {B} and {C}.

When each of the charging stations C1-C3 is connected to the gateway device 120, the OCPP relay service 410 may build a corresponding connection handler 413, 414, 416 for each of the charging stations C1-C3. Each of the connection handlers 413, 414, 416 may be bound to an endpoint of the local OPCC server 412 based on a unique ID (e.g. client IDs of the charging stations), such that the OCPP messages from a specific charging station or sent to the specific charging station may be routed to the connection handler corresponding to the specific charging station. For example, a OCPP message from the charging station C1 or sent to the charging station C1 may be routed to the connection handler 413 based on the client ID {A} in the OCPP message.

In some embodiments, the gateway device 120 may receive a user configuration to obtain the charging station ID of the charging station and a Digital Certificate of the charging station. The gateway device 120 may determine the client ID of the charging station according to the charging station ID of the charging station or the Digital Certificate of the charging station. The gateway device 120 may create a connection handler with the client ID, wherein the connection handler is configured to parse the first protocol message and generate the payload information with the indication tag.

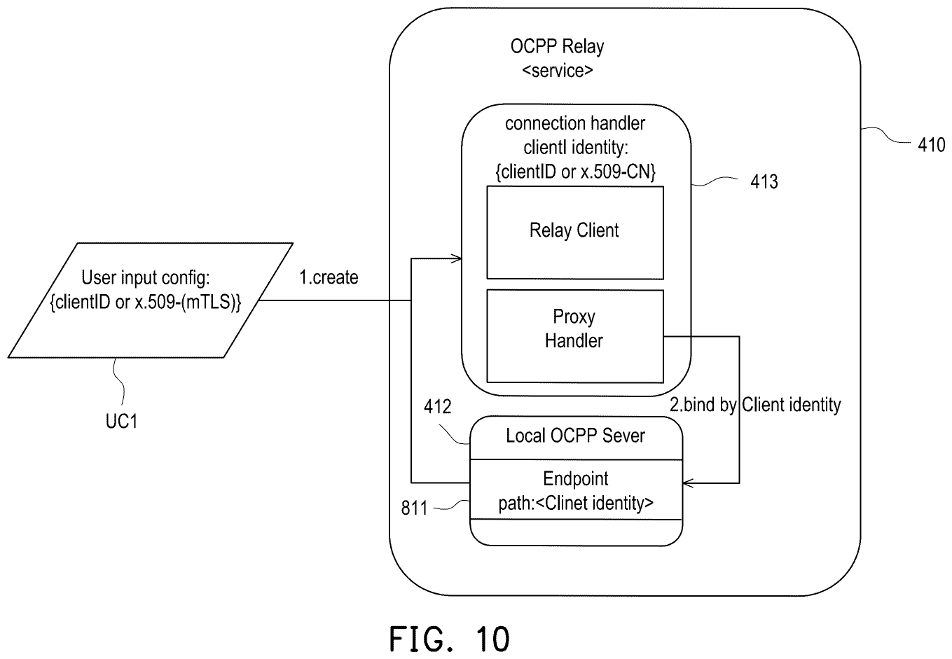

In detail, FIG. 10 is a schematic diagram that illustrates relation between local OCPP server and multiple connection handlers according to an exemplary embodiment of the present disclosure. Referring to FIG. 10, in some embodiments, in order to build a connection handler 413 for a charging station C1, a user input configuration UC1 inputted by a user may be received by the OCPP relay service 410. The user input configuration UC1 may include a client ID or a Transport Layer Security (TLS) data. In some embodiments, when the TLS data, such as a X.509 certificate, is inputted, a Common Name (CN name) may be obtained by the OCPP relay service 410. Therefore, when building a connection handler 413 for a charging station C1, the OCPP relay service 410 may configure the inputted client ID or the CN name as a client ID of the connection handler 413. Further, the local OCPP server 412 may create an endpoint 811 according to the user input configuration UC1, such that the endpoint 811 may be bound to the corresponding connection handler 413 by establishing a URL path according to the client ID.

In some embodiments, the gateway device 120 may decrypt the first protocol message (e.g. OPCC message) to obtain the payload information according to the Digital Certificate of the charging station C1 by using the connection handler 413 with the client ID.

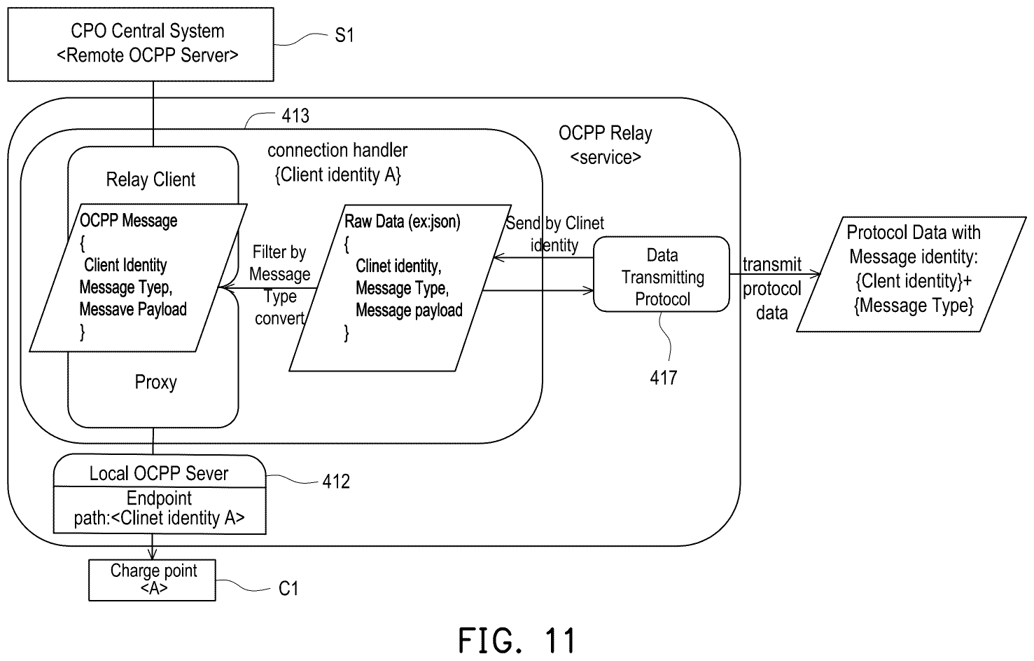

FIG. 11 is a schematic diagram that illustrates operation of a connection handler according to an exemplary embodiment of the present disclosure. Referring to FIG. 9 and FIG. 11 together, a charging station C1 may be connected to an endpoint of the local OCPP sever 412, and the endpoint is bound to a connection handler 413 with a client ID, which may be a client ID {A} of the charging station C1. When the gateway device 120 receives a OCPP message 1111 from the charging station C1, the OCPP message 1111 may be sent to the OCPP remote server (i.e., a CPO central system) S1 by the corresponding connection handler 413. Further, the connection handler 413 may parse the OCPP message 1111 to determine whether to forward the data in the OCPP message 1111 to an external entity. In detail, the connection handler 413 may determine whether the message type, the message payload or other data in OCPP message 1111 satisfy with a preset condition. If the message type, the message payload of the OCPP message or other data in OCPP message satisfy with the preset condition, the connection handler 413 may generate raw data 1112 (e.g., JSON data) according to the message type and the message payload of the OCPP message 1111 and the client ID of the connection handler 413. Raw data 1112 is transmitted to the data transmit protocol module 417. The data transmit protocol module 417 may convert the raw data 1112 in to a protocol data including the message type of the OCPP message 1111 and the client ID, wherein the indication tag also referred as message identify may includes type of the OCPP message 1111 and the client ID. The message ID is determined according to the message payload of the OCPP message 1111. Such that, the external entity may be determine whether to receive the second protocol message according to the message ID in the second protocol message. The protocol data is sent from the data transmit protocol module 417 to a message handler 423 of the protocol service 420 of the gateway device 120 by using UNIX, Transmission Control Protocol (TCP), Inter-Process Communication (IPC) or Remote Procedure Call (RPC).

In summary, in the disclosure, the data sent to the OCPP remote server fromterminal equipment may also be sent to a server of an external entity, which does not support OCCP. Therefore, such Y shape data transmission ensures that control and management of the terminal equipment can be more efficient and versatile.

No element, act, or instruction used in the detailed description of disclosed embodiments of the present application should be construed as absolutely-critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for relaying message for terminal equipment, adapted to a gateway device, comprising:
receiving a first protocol message complied with a first application layer protocol from a terminal equipment;
transmitting the first protocol message complying with the first application layer protocol to a first remote server;
converting the first protocol message to a second protocol message complying with a second application layer protocol; and
transmitting the second protocol message complying with the second application layer protocol to a second remote server.

2. The method according to claim 1, wherein the terminal equipment comprises a charging station.

3. The method according to claim 1, wherein the first application layer protocol comprises Open Charge Point Protocol (OCPP), and the first protocol message comprises a OCPP message.

4. The method according to claim 3, wherein the first remote server comprises a remote OPCC server.

5. The method according to claim 3, wherein the second remote server connected to the gateway device via a local controller, and the second protocol message is transmitted to the second remote server via the local controller.

6. The method according to claim 1, wherein the step of converting the first protocol message to the second protocol message complying with the second application layer protocol comprises:
parsing the first protocol message to obtain payload information in the first protocol message;
generating a protocol data with an indication tag according to the payload information; and
encapsulating the protocol data with the indication tag into the second protocol message according to the second application layer protocol.

7. The method according to claim 6, wherein the step of generating the protocol data with the indication tag according to the payload information comprises:
in response to a message type of the first protocol message satisfying a filtering condition, generating the indication tag by combining the message type of the first protocol message and a client ID of the terminal equipment; and
adding the indication tag to the payload information of the first protocol message to generating the protocol data with the indication tag.

8. The method according to claim 6, wherein the step of encapsulating the protocol data into the second protocol message according to the second application layer protocol comprises:
in response to the indication tag of the protocol data is a specific indication tag, performing a protocol converting process to encapsulate the protocol data into the second protocol message according to the second application layer protocol; and
in response to the indication tag of the protocol data is not the specific indication tag, disabling performing the protocol converting process.

9. The method according to claim 6, further comprising:
receiving a user configuration to obtain the terminal equipment ID of the terminal equipment and a Digital Certificate of the terminal equipment;
determining the client ID of the terminal equipment according to the terminal equipment ID of the terminal equipment or the Digital Certificate of the terminal equipment; and
creating a connection handler with the client ID, wherein the connection handler is configured to parse the first protocol message and generate the payload information with the indication tag.

10. The method according to claim 7, wherein the step of parsing the first protocol message to obtain the payload information in the first protocol message comprises:
decrypting the first protocol message to obtain the payload information according to the Digital Certificate of the terminal equipment by using the connection handler with the client ID.

11. A gateway device, comprising:
a transmitter;
a storage device;
a processor, coupled to the storage device and the transmitter and configured to:
receive a first protocol message complied with a first application layer protocol from a terminal equipment;
transmit the first protocol message complying with the first application layer protocol to a first remote server;
convert the first protocol message to a second protocol message complying with a second application layer protocol; and
transmit the second protocol message complying with the second application layer protocol to a second remote server.

12. The gateway device according to claim 11, wherein the terminal equipment comprises a charging station.

13. The gateway device according to claim 11, wherein the first application layer protocol comprises Open Charge Point Protocol (OCPP), and the first protocol message comprises a OCPP message.

14. The gateway device according to claim 13, wherein the first remote server comprises a remote OPCC server.

15. The gateway device according to claim 13, wherein the second remote server connected to the gateway device via a local controller, and the second protocol message is transmitted to the second remote server via the local controller.

16. The gateway device according to claim 11, wherein the processor is further configured to:
parse the first protocol message to obtain payload information in the first protocol message;
generate a protocol data with an indication tag according to the payload information; and
encapsulate the protocol data with the indication tag into the second protocol message according to the second application layer protocol.

17. The gateway device according to claim 16, wherein the processor is further configured to:
in response to a message type of the first protocol message satisfying a filtering condition, generate the indication tag by combining the message type of the first protocol message and a client ID of the terminal equipment; and
add the indication tag to the payload information of the first protocol message to generating the protocol data with the indication tag.

18. The gateway device according to claim 16, wherein the processor is further configured to:
in response to the indication tag of the protocol data is a specific indication tag, perform a protocol converting process to encapsulate the protocol data into the second protocol message according to the second application layer protocol; and
in response to the indication tag of the protocol data is not the specific indication tag, disable performing the protocol converting process.

19. The gateway device according to claim 16, wherein
receive a user configuration to obtain the terminal equipment ID of the terminal equipment and a Digital Certificate of the terminal equipment;
determine the client ID of the terminal equipment according to the terminal equipment ID of the terminal equipment or the Digital Certificate of the terminal equipment; and
create a connection handler with the client ID, wherein the connection handler is configured to parse the first protocol message and generate the payload information with the indication tag.

20. The gateway device according to claim 19, wherein the processor is further configured to:
decrypt the first protocol message to obtain the payload information according to the Digital Certificate of the terminal equipment by using the connection handler with the client ID.
